(19) United States
(12) Patent Application Publication
(10) Pub. No.: US 2023/0213947 A1
(43) Pub. Date: Jul. 6, 2023

(54) VEHICLE AND METHOD FOR LOCATING A VEHICLE

(71) Applicant: PRINOTH S.P.A., Vipiteno (IT)

(72) Inventor: Martin Kirchmair, Vipiteno (IT)

(21) Appl. No.: 18/084,356

(22) Filed: Dec. 19, 2022

(30) Foreign Application Priority Data
Dec. 30, 2021 (IT) 102021000033116

(51) Int. Cl. G05D 1/02; G01C 21/00

(52) U.S. Cl. CPC G05D 1/0274; G01C 21/005; G05D 2201/0202

(57) ABSTRACT

Method for locating a vehicle, such as a crawler vehicle and in particular a snow grooming vehicle, within a working region, the working region comprising at least one reference element. The method comprising: acquiring a reference model of the working region comprising reference data relating to the at least one reference element; detecting, via at least one sensor of the vehicle, data relating to an area of the working region surrounding the vehicle; comparing the data detected by the at least one sensor with the reference data to verify whether at least a part of the data detected by the at least one sensor corresponds to the reference data; and determining a position of the vehicle within the working region on the basis of the comparison between the data detected by the at least one sensor and the reference data.

### PRIORITY CLAIM

This application claims the benefit of and priority to Italian Patent Application No. 102021000033116, filed on Dec. 30, 2021, the entire contents of which is incorporated herein by reference.

### TECHNICAL FIELD

The present disclosure relates to: a vehicle, such as a crawler vehicle and in particular a snow grooming vehicle; a method for locating a vehicle, such as a crawler vehicle; and a method for controlling a vehicle, such as a crawler vehicle.

### BACKGROUND

The localization of a crawler vehicle is carried out by GNSS systems (Global Navigation Satellite Systems), for example the American GPS system (Global Positioning System). To operate, the navigation satellite system must receive signals from satellites. Therefore, if there are problems concerning the reception of such signals, the localization could fail. For example, in case of a snow grooming vehicle, there can be signal reception problems if the snow grooming vehicle operates in a closed environment or in a place where the mountain conformation does not allow for a relatively good satellite signal reception.

A purpose of the present disclosure is to provide a crawler vehicle, in particular a snow grooming vehicle, a method for locating a crawler vehicle and a method for controlling a crawler vehicle, which can overcome or at least mitigate at least certain of the aforementioned problems.

### SUMMARY

In certain embodiments, the present disclosure relates to a method for locating a vehicle within a working region comprising at least one reference element. In these embodiments, the method includes acquiring a reference model of the working region comprising reference data relating to the at least one reference element, wherein the at least one reference element is at least part of a physical object visible from at least one point within the working region. The method also includes detecting, via at least one sensor of the vehicle, data relating to an area of the working region surrounding the vehicle, and comparing the data detected by the at least one sensor with the reference data to verify whether at least a part of the data detected by the at least one sensor corresponds to at least a part of the reference data. The method further includes determining a position of the vehicle within the working region based on the comparison between the data detected by the at least one sensor and the reference data. In certain embodiments, the present disclosure further relates to a vehicle configured to be located by such a method.

It should be appreciated that such a configuration provides that the crawler vehicle can be located under any use condition and in any environment in which it is located, even in closed environments and/or even in areas where the position detection satellite signal cannot be received, for example in places where, due to the particular land conformation, the position detection signal of the satellites cannot be received or in remote areas of the globe that are not covered by position detection satellites.

In certain embodiments, the present disclosure also relates to a method for determining the height of a snowpack within a working region of a vehicle. In these embodiments, the method includes determining a position of the vehicle within the working region by acquiring a reference model of the working region comprising reference data relating to at least one reference element of the working region, wherein the at least one reference element is at least part of a physical object visible from at least one point within the working region, detecting, via at least one sensor of the vehicle, data relating to an area of the working region surrounding the vehicle, comparing the data detected by the at least one sensor with the reference data to verify whether at least a part of the data detected by the at least one sensor corresponds to at least a part of the reference data, and determining the position of the vehicle within the working region based on the comparison between the data detected by the at least one sensor and the reference data. In these embodiments, the method additional includes comparing the position of the vehicle with the reference model. The present disclosure further relates to a method for controlling a vehicle based on the above-described method of determining a location of the vehicle and the above-described method for determining the height of a snowpack within a working region of the vehicle.

### BRIEF DESCRIPTION OF THE DRAWINGS

For a better understanding of the present disclosure, an example embodiment is described below, by way of non-limiting example and with reference to the accompanying drawings, wherein:

FIG. 1 is a side view of a crawler vehicle according to the present disclosure;

FIG. 2 is a schematic view of the vehicle of FIG. 1 in a closed environment;

FIG. 3 is a view from a point within a working region belonging to the closed environment of FIG. 2;

FIG. 4 is a schematic view of the vehicle of FIG. 1 in an open environment;

FIG. 5 is a view from a point within a working region belonging to the open environment of FIG. 4; and

FIG. 6 is a block diagram of a location device of the vehicle of FIG. 1.

### DETAILED DESCRIPTION

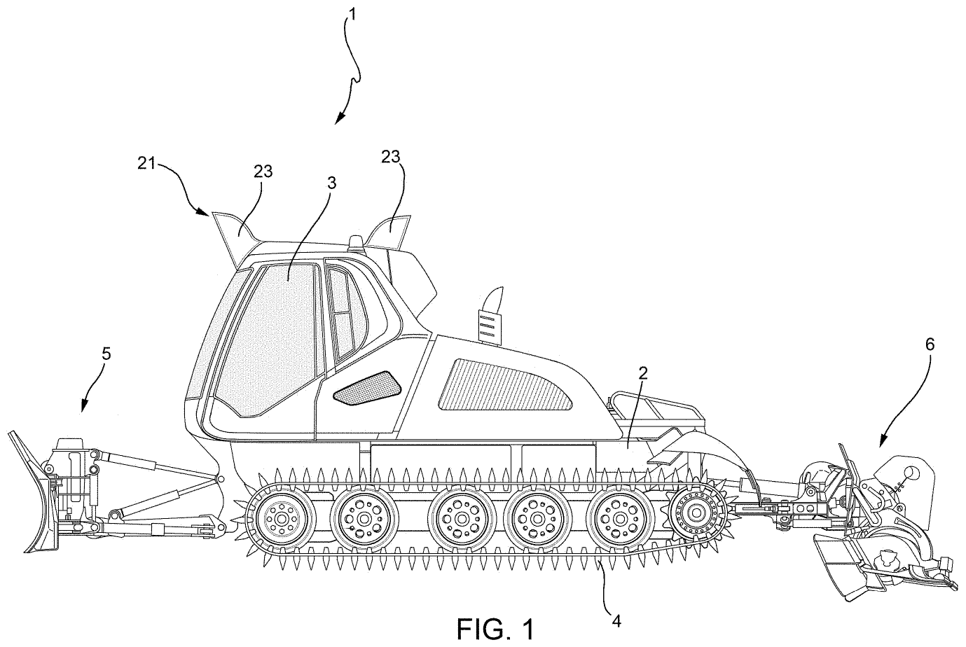

With reference to FIG. 1, there is indicated by 1 a crawler vehicle according to the present disclosure. In the embodiment shown in FIG. 1, the crawler vehicle 1 is a snow grooming vehicle. In another embodiment (which is not shown), the crawler vehicle 1 is a vegetation management vehicle. In another embodiment (which is not shown), the crawler vehicle 1 is a multipurpose tracked vehicle to carry out tasks of different sorts in uneven grounds of different sorts.

The crawler vehicle 1 comprises a frame 2, a driver's cabin 3 housed on the frame 2, a pair of tracks 4 (only one of them being shown in FIG. 1) and at least one tool, for example a blade or shovel 5, supported at the front by the frame 2, and/or a tiller assembly 6, supported at the rear by the frame 2.

The crawler vehicle 1 can move within a working region 11, which can belong to a closed or open environment.

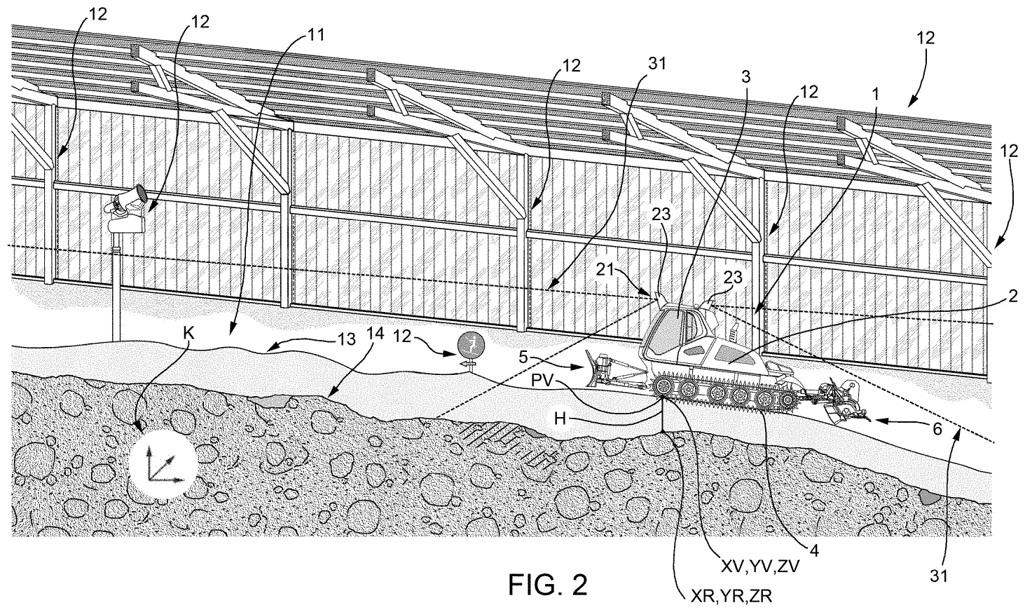

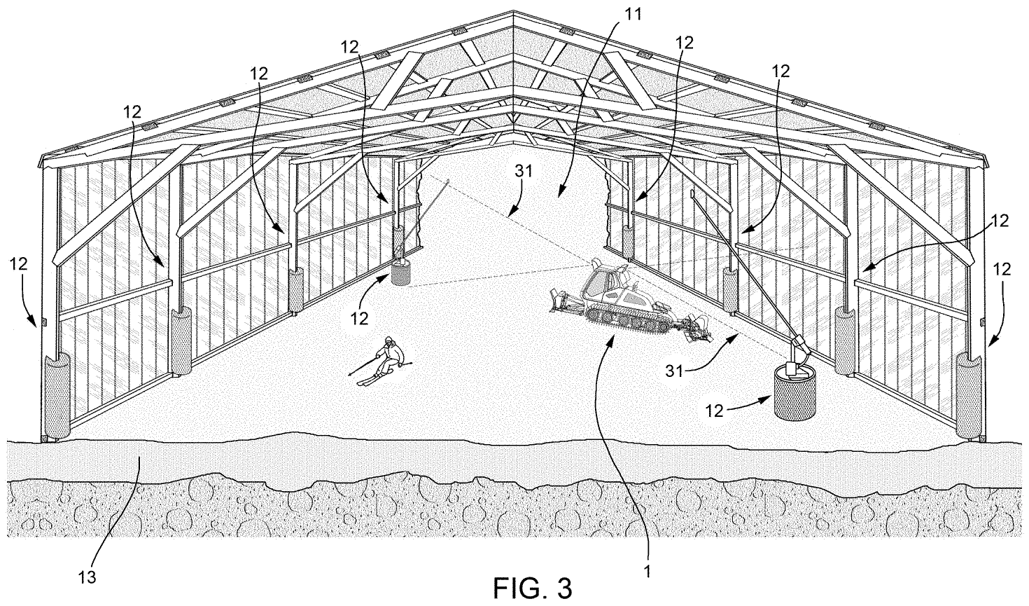

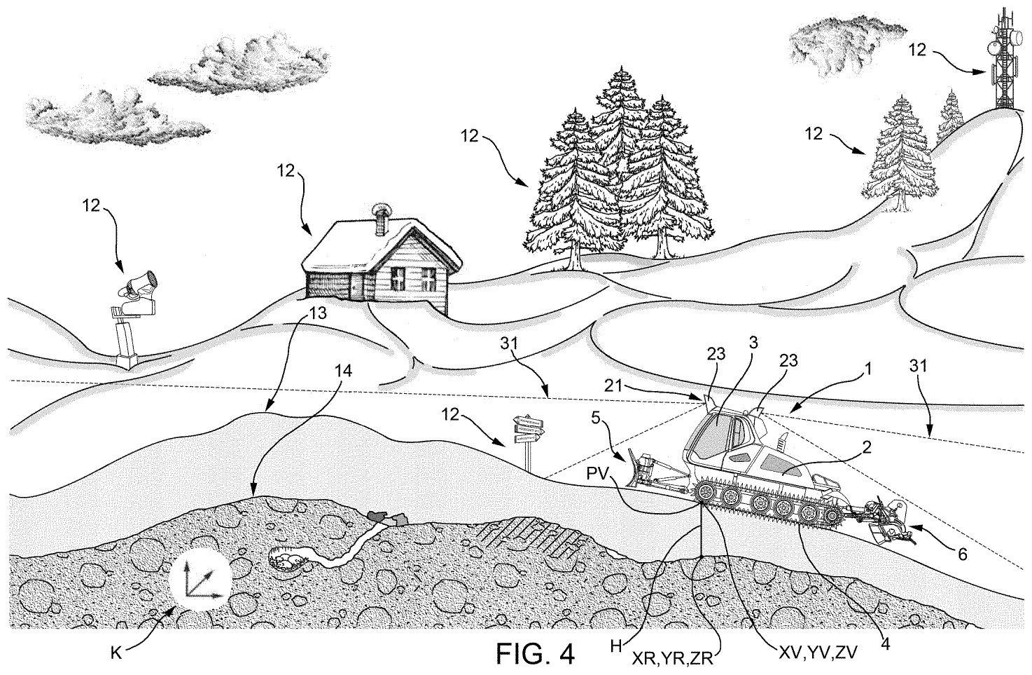

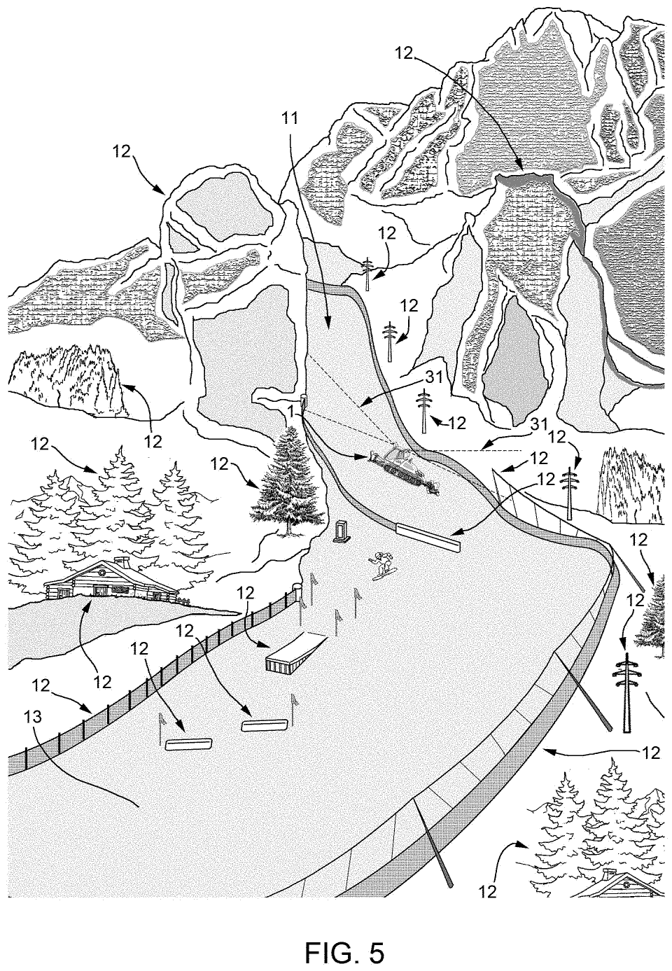

The working region 11 (e.g., a ski slope) can be indoors (FIGS. 2 and 3) and/or outdoors (FIGS. 4 and 5), and comprises at least one reference element 12.

In particular, the at least one reference element 12 is a physical object, or part thereof, visible from at least one point within the working region 11 and at least partly not covered by the snowpack 13.

The at least one reference element 12 can be an artificial element, for example a post or a station of a cableway, a snow cannon, a building of any kind, a fixed fence, a ceiling or a side wall of a covered ski area.

The at least one reference element 12 can be a natural element, for example a tree, a stone, a portion of a mountain or hill or plain.

With reference to FIGS. 2 and 4, the crawler vehicle 1 comprises a location device 21, which is configured to determine a position PV of the crawler vehicle 1 within the working region 11 (i.e., the position of a predetermined point of the crawler vehicle 1 with respect to a fixed reference system K).

The fixed reference system K can be a global reference system (i.e., the same of navigation satellite systems). Alternatively, the fixed reference system K can be a local reference system (i.e., relating to the working region 11). In this case, the origin of the fixed reference system K can be a predetermined point of the working region 11, for example a point belonging to the soil 14.

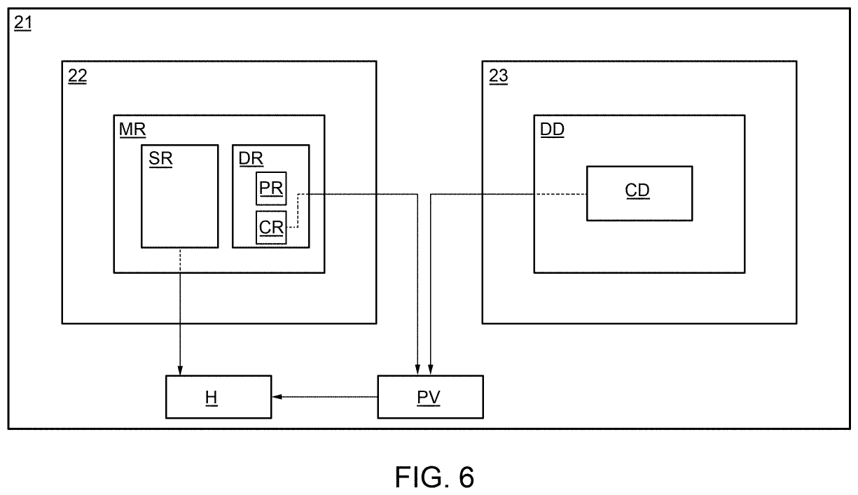

The location device 21 (FIG. 6) comprises a memory 22 and at least one sensor 23.

The memory 22 is configured to store a reference model MR of the working region 11 comprising reference data DR, relating to the at least one reference system 12 of the working region 11, and characterization data SR, relating to a three-dimensional characterisation of the soil 14.

The characterization data SR enables a three-dimensional model of the soil 14 to be obtained.

The reference data DR comprises a position PR and a conformation CR of the at least one reference element 12. In particular, each conformation CR is coupled to a respective position PR. In particular, the conformation CR comprises data representative of a profile and/or profiles and/or an outline and/or outlines and/or a surface and/or surfaces and/or details of the at least one reference element 12.

Conveniently, the characterisation data SR and the position of the at least one reference element 12 are expressed via coordinates, for example Cartesian or cylindrical coordinates, with respect to the fixed reference system K.

The characterisation data SR relating to the soil 14 and/or the reference data DR relating to the at least one reference element 12, in particular the position PR and the conformation CR of the at least one reference element 12, can be acquired by three-dimensionally scanning the working region 11 and/or by three-dimensionally modelling the working region 11.

In an alternative embodiment, the characterisation data SR relating to the soil 14 are provided by a map produced by a third entity, for example a map provided by a military or civil geographical institute.

After such process, the three-dimensional reference model MR of the working region 11 is obtained, which can be changed. In particular, any change to the soil 14 and/or to the at least one reference element 12 can be reproduced in the reference model MR, by scanning again the working region 11 or part thereof and/or by three-dimensionally modelling again the working region 11 or part thereof. For example, a new reference element 12 can be added to the reference model MR and/or a reference element 12, already present in the reference model MR, can be removed or the position PR and/or the conformation CR thereof can be changed.

In a non-limiting embodiment of the present disclosure, the scanning performed to obtain the reference model MR is carried out with a crawler vehicle 1 with the at least one sensor 23.

In another non-limiting embodiment of the present disclosure, the location device 21 comprises a neural network and the reference model MR, or part thereof, is defined by the parameters of the configuration and/or of the setting of the neural network obtained via a learning process of the neural network. In other words, the parameters of the reference model MR can be the parameters of the neural network properly trained with a learning process to recognise the reference elements 12 or the reference model MR can be defined by the neural network itself properly trained with a learning process to recognise the reference elements 12.

In certain embodiments, the at least one sensor 23 is chosen from the group comprising lidar, radar, camera, video camera, thermal camera, and/or proximity sensor, such as magnetic or ultrasonic.

The at least one sensor 23 is housed on the crawler vehicle 1, for example is rigidly coupled to the frame 2 or to the driver's cabin 3 or to one of the tools 5, 6 of the crawler vehicle 1. In particular, the memory 22 is configured to store position and orientation of the at least one sensor 23 with respect to the crawler vehicle 1 (i.e., with respect to the predetermined point of the crawler vehicle 1). Therefore, the location device 21 is configured to determine the position PV of the crawler vehicle 1 (i.e., the position of the predetermined point of the crawler vehicle 1 with respect to the fixed reference system K), on the basis of the position and the orientation of the at least one sensor 23 with respect to the fixed reference system K, via kinematic relationships of transformation of reference systems.

Conveniently, the location device 21 is configured to determine, via kinematic relationships of transformation of reference systems, the orientation of the crawler vehicle 1, for example the orientation of a longitudinal axis along which the frame 2 extends, with respect to the fixed reference system K.

Furthermore, the location device 21 is configured to determine position and orientation of any component of the crawler vehicle 1 (for example of the blade or shovel 5 and/or of the tiller assembly 6).

The at least one sensor 23 (FIG. 6) is configured to detect data DD relating to an area 31 of the working region 11 surrounding the crawler vehicle 1. Therefore, the area 31 moves together with the crawler vehicle 1. In particular, the area 31 is defined by the framing of the at least one sensor 23.

The data DD detected by the at least one sensor 23 comprise a conformation CD of the area 31 of the working region 11 surrounding the crawler vehicle 1.

The at least one sensor 23 is configured to cyclically scan the area 31 of the working region 11 surrounding the crawler vehicle 1 so as to detect the data DD relating to the area 31, in particular so as to detect a conformation CD of the area 31.

The location device 21 is configured to compare the data DD detected by the at least one sensor 23 with the reference data DR, so as to verify whether at least a part of the data DD detected by the at least one sensor 23 corresponds to, in certain instances at least a part of, the reference data DR.

In certain embodiments, the detected data DD are in the same format as the reference data DR, so as to be relatively easily comparable therewith. In particular, the location device 21 is configured to seek correspondences between a conformation CD of the area 31 of the working region 11 surrounding the vehicle 1 and a conformation CR of the at least one reference element 12.

Furthermore, the location device 21 is configured to determine the position PV of the crawler vehicle 1 within the working region 11 on the basis of the comparison between the data DD detected by the at least one sensor 23 and the reference data DR. In particular, the location device 21 is configured to determine the position PV of the crawler vehicle 1 on the basis of the position PR of the at least one reference element 12, if at least a part of the area 31 of the working region 11 surrounding the crawler vehicle 1 has a conformation CD corresponding to the conformation CR of the at least one reference element 12. In other words, the location device 21 compares the conformation CD of the detected area 31 with the conformation CR of the at least one reference element 12. If at least a part of the conformation CD of the area 31 corresponds to the conformation CR of the at least one reference element 12, the location device determines position and orientation of the at least one sensor 23 of the crawler vehicle 1 and, in turn, the position PV of the crawler vehicle 1.

In more detail, the location device 21 compares the conformation CD of the detected area 31 with the conformation CR of the at least one reference element 12. If at least a part of the conformation CD of the area 31 corresponds to the conformation CR of the at least one reference element 12, the location device defines the position PV of the crawler vehicle 1 on the basis of the position PR coupled to the reference conformation CR that at least partly corresponds to the detected conformation CD.

In more detail, the location device 21 compares the conformation CD of the detected area 31 with the conformation CR of the at least one reference element 12. If at least a part of the conformation CD of the area 31 corresponds to the conformation CR of the at least one reference element 12, the location device reads from the memory 22 the position PR coupled to the reference conformation CR that at least partly corresponds to the detected conformation CD and determines position and orientation of the at least one sensor 23 of the crawler vehicle 1 based on such position PR and on values defined by the comparison between the conformation CD and the conformation CR. In other words, position and orientation of the at least one sensor 23 are such that, looking at the reference model MR from such position and with such orientation, at least a part of the conformation CD of the area 31 corresponds to the conformation CR of the at least one reference element 12. Since the conformation CR of the at least one reference element is coupled to the respective position PR and stored in the memory 22, the location device 21 traces the position PV of the crawler vehicle 1.

Additionally, the location device 21 defines the position PV and the orientation of the crawler vehicle 1 on the basis of the determined position and orientation of the at least one sensor 23.

In an embodiment, position and orientation of the at least one sensor 23 and of the crawler vehicle 1 coincide.

In another embodiment, position and orientation of the at least one sensor 23 and of the crawler vehicle 1 are linked to each other by a predetermined relationship, in particular the predetermined relationship can be a function or a matrix. In other words, the location device 21 determines the position PV of the crawler vehicle 1 by cyclically detecting the conformations CD. When one of them at least partly corresponds to one of the stored conformations CR, the location device uses the position PR, coupled to the conformation CR selected by the comparison, and the values defined by the comparison to define the position of the crawler vehicle 1. In certain embodiments, the values defined by the comparison define distance and orientation between the reference element 12, identified by the comparison between the conformation CR and the conformation CD, and the at least one sensor 23.

In certain embodiments, the present disclosure also relates to a method for locating a crawler vehicle 1, in particular a snow grooming vehicle, within a working region 11, the working region 11 comprising at least one reference element 12, such as the working region 11 being a ski slope. The method includes acquiring a reference model MR of the working region 11 comprising reference data DR relating to the at least one reference element 12, the at least one reference element 12 being a physical object, or part thereof, visible from at least one point within the working region 11 and such as at least partly not covered by the snowpack 13. The method also includes detecting, via at least one sensor 23 of the crawler vehicle 1, data DD relating to an area 31 of the working region 11 surrounding the crawler vehicle 1. The at least one sensor 23 is selected from the group comprising: lidar, radar, camera, video camera, thermal camera, proximity sensor such as magnetic or ultrasonic. In certain instances, the detected data DD is in the same format as the reference data DR such as the data DD comprising a conformation.

The method of these embodiments also includes comparing the data DD detected by the at least one sensor 23 with the reference data DR, to verify whether at least a part of the data DD detected by the at least one sensor 23 corresponds to, in certain instances, at least a part of, the reference data DR. The method further includes determining a position PV of the crawler vehicle 1 within the working region 11 on the basis of the comparison between the data DD detected by the at least one sensor 23 and the reference data DR.

The position PV of the crawler vehicle 1 within the working region 11 can be used to determine the height H of the snowpack 13, which corresponds to the thickness of the snowpack 13 underneath the crawler vehicle 1. In such embodiments, after having determined the position PV of the crawler vehicle 1 within the working region 11, the position PV of the crawler vehicle 1 can be compared with the reference model MR. In particular, it is possible to calculate a difference H between a height ZV of the crawler vehicle 1 and a height ZR of the reference model MR, wherein: [XV, YV, ZV] is the position PV of the crawler vehicle 1 with respect to the fixed reference system K; and [XR, YR, ZR] is the position, with respect to the fixed reference system K, of a point belonging to the reference model MR, in particular it is the position of a point lying on the soil 14 and thus belonging to the characterisation data SR relating to the soil 14, so that XR=XV and YR=YV.

In certain embodiments, PV can be chosen as the position of a point of the crawler vehicle 1 in contact with the snowpack 13. In this case, the height H of the snowpack 13 is equal to the difference H=ZV−ZR.

In case the snowpack 13 is not present, then ZR=ZV and thus H=0 (i.e., the crawler vehicle 1 lies on the soil 14).

The localization of the crawler vehicle 1 and the height H of the snowpack 13 can be used to control the crawler vehicle 1. In particular, the blade and/or shovel 5 and/or the tiller assembly 6 can be operated so as to conform the snowpack 13 to a target map, stored in the memory 22 and representative of a desired surface to be obtained by processing the snowpack 13.

In certain embodiments, based on the localization of the crawler vehicle 1, on the height H of the snowpack and on the target map, the blade and/or shovel 5 and/or the tiller assembly 6 can be operated so as to cause a removal of the snowpack 13 such as to conform the snowpack 13 to the target map.

In an alternative non-limiting embodiment of the present disclosure (which is not shown in the figures), the vehicle 1 is not a crawler vehicle and comprises a plurality of wheels comprising respective tyres.

It should be appreciated that the localization of the crawler vehicle 1 does not require navigation satellite systems and is possible even if the crawler vehicle 1 operates in a closed environment or in a place where the mountain conformation does not enable for a relatively good satellite signal reception.

Furthermore, the localization of the crawler vehicle 1 can be used to determine the height H of the snowpack 13 with no need for dedicated sensors.

Furthermore, the method for locating the crawler vehicle 1 and the method for determining the height H of the snowpack 13 can be used to control the crawler vehicle 1, thus enabling for an assisted or autonomous operation thereof. In other words, in accordance with the present disclosure and via the at least one sensor 23 of the location device 21 (for example a lidar or a video camera, and without the aid of a GPS system), it is possible to determine the position PV of the crawler vehicle 1 by scanning the surrounding environment. In particular, the location device 21 cyclically scans an area 31 surrounding the crawler vehicle 1 and, via the recognition of a reference element 12, for example the profile of a portion of a natural element present in the surrounding environment, such as a portion of a mountain or hill or plain, or a post or a station of a cableway or a snow cannon, determines the position of the crawler vehicle 1.

Finally, it should be appreciated that modifications and variations can be made to the crawler vehicle 1 and the methods without going beyond the scope of protection defined by the appended claims. Accordingly, various changes and modifications to the presently disclosed embodiments will be apparent to those skilled in the art.

The invention claimed is:

1. A method for locating a vehicle within a working region comprising at least one reference element, the method comprising:
acquiring a reference model of the working region comprising reference data relating to the at least one reference element, wherein the at least one reference element is at least part of a physical object visible from within the working region;
detecting, via at least one sensor of the vehicle, data relating to an area of the working region surrounding the vehicle;
comparing the data detected by the at least one sensor with the reference data to verify whether at least a part of the data detected by the at least one sensor corresponds to at least a part of the reference data; and
determining a position of the vehicle within the working region based on the comparison between the data detected by the at least one sensor and the reference data.

2. The method of claim 1, wherein the reference model comprises characterization data relating to a three-dimensional characterization of soil, and the reference data relates to the at least one reference element of the working region.

3. The method of claim 1, wherein the reference data comprises a position and a conformation of the at least one reference element.

4. The method of claim 1, wherein the data detected by the at least one sensor comprises a conformation of the area of the working region surrounding the vehicle.

5. The method of claim 1, wherein acquiring the reference model of the working region comprises three-dimensionally scanning the working region.

6. The method of claim 1, wherein acquiring the reference model of the working region comprises three-dimensionally modelling the working region.

7. The method of claim 1, wherein detecting, via the at least one sensor of the vehicle, data relating to the area of the working region surrounding the vehicle comprises cyclically scanning, via the at least one sensor, the area of the working region surrounding the vehicle to detect the data relating to that area.

8. The method of claim 1, wherein comparing the data detected by the at least one sensor with the reference data comprises seeking correspondences between a conformation of the area of the working region surrounding the vehicle and a conformation of the at least one reference element.

9. The method of claim 1, wherein determining the position of the vehicle within the working region comprises determining the position of the vehicle based on a position of the at least one reference element and at least a part of the area of the working region surrounding the vehicle having a conformation corresponding to a conformation of the at least one reference element.

10. The method of claim 1, wherein the at least one sensor is selected from a group comprising: a lidar, a radar, a camera, a video camera, a thermal camera, and a proximity sensor.

11. The method of claim 1, wherein the detected data is in the same format as the reference data.

12. A method for determining a height of a snowpack within a working region of a vehicle, the method comprising:
determining a position of the vehicle within the working region by:
acquiring a reference model of the working region comprising reference data relating to at least one reference element of the working region, wherein the at least one reference element is at least part of a physical object visible from within the working region,
detecting, via at least one sensor of the vehicle, data relating to an area of the working region surrounding the vehicle,
comparing the data detected by the at least one sensor with the reference data to verify whether at least a part of the data detected by the at least one sensor corresponds to at least a part of the reference data, and
determining the position of the vehicle within the working region based on the comparison
between the data detected by the at least one sensor and the reference data; and
comparing the position of the vehicle with the reference model.

13. The method of claim 12, wherein comparing the position of the vehicle with the reference model comprises calculating a difference between an altitude of the vehicle and an altitude of the reference model.

14. A method comprising:
controlling a vehicle based on a location of the vehicle within a working region and a height of a snowpack, wherein at least one of the location of the vehicle and the height of the snowpack is determined by:
acquiring a reference model of the working region comprising reference data relating to at least one reference element of the working region, wherein the at least one reference element is at least part of a physical object visible from within the working region,
detecting, via at least one sensor of the vehicle, data relating to an area of the working region surrounding the vehicle,
comparing the data detected by the at least one sensor with the reference data to verify whether at least a part of the data detected by the at least one sensor corresponds to at least a part of the reference data, and
determining a position of the vehicle within the working region based on the comparison between the data detected by the at least one sensor and the reference data,
wherein the height of the snowpack is further determined by comparing the position of the vehicle with the reference model.

15. The method of claim 14, wherein the vehicle comprises a snow grooming vehicle configured to move on the snowpack and comprising at least one tool configured to modify the snowpack, and controlling the vehicle further comprises operating the at least one tool to conform the snowpack to a target map representative of a desired surface to be obtained by processing the snowpack.

16. A vehicle comprising:
a location device configured to locate the vehicle within a working region by:
acquiring a reference model of the working region comprising reference data relating to at least one reference element of the working region, wherein the at least one reference element is at least part of a physical object visible from within the working region,
detecting, via at least one sensor of the vehicle, data relating to an area of the working region surrounding the vehicle,
comparing the data detected by the at least one sensor with the reference data to verify whether at least a part of the data detected by the at least one sensor corresponds to at least a part of the reference data, and
determining a position of the vehicle within the working region based on the comparison between the data detected by the at least one sensor and the reference data

17. A vehicle configured to move within a working region, the vehicle comprising:
a location device comprising:
at least one memory configured to store a reference model of the working region comprising reference data relating to at least one reference element of the working region, and
at least one sensor selected from a group of: a lidar, a radar, a camera, a video camera, a thermal camera, and a proximity sensor, the at least one sensor being configured to detect data relating to an area of the working region surrounding the vehicle,
the location device being configured to:
compare the data detected by the at least one sensor with the reference data to verify whether at least a part of the data detected by the at least one sensor corresponds to at least a part of the reference data, and
determine a position of the vehicle within the working region based on the comparison between the data detected by the at least one sensor and the reference data.

18. The vehicle of claim 17, wherein the proximity sensor comprises at least one of a magnetic proximity sensor and an ultrasonic proximity sensor.
